(19) United States
(12) Patent Application Publication
(10) Pub. No.: US 2025/0295080 A1
(43) Pub. Date: Sep. 25, 2025

(54) WATERING CONTROL SYSTEM AND METHOD

(71) Applicant: Fujian OralGarden Technology Co., Ltd., Fuzhou (CN)

(72) Inventor: Dun ZHENG, Fuzhou (CN)

(73) Assignee: Fujian OralGarden Technology Co., Ltd., Fuzhou (CN)

(21) Appl. No.: 19/227,837

(22) Filed: Jun. 4, 2025

Related U.S. Application Data
(63) Continuation of application No. PCT/CN2025/085695, filed on Mar. 28, 2025.

(51) Int. Cl. A01G 25/16

(52) U.S. Cl. CPC A01G 25/16

(57) ABSTRACT

A watering control system includes a watering signal transmitter and at least one watering signal receiver. The watering signal transmitter includes a first processing unit and a wireless transmitting circuit, the watering signal receiver includes a second processing unit, a wireless receiving circuit, a drive circuit, and a control valve, and an output end of the drive circuit is electrically connected to the control valve.

### CROSS-REFERENCE TO RELATED APPLICATIONS

This application is a continuation of International Application No. PCT/CN2025/085695, filed on Mar. 28, 2025, the content of which is incorporated herein by reference in its entirety.

### TECHNICAL FIELD

The present disclosure relates to the technical field of garden watering, and in particular to a watering control system and method.

### BACKGROUND

Generally, residential communities and courtyards have gardens where flowers and trees are grown. A garden typically has more than two sprinkler heads each connected to a watering pipeline used for watering, and the watering pipeline is equipped with a manual ball valve. People walk from their house to the garden, reach a location of the manual ball valve that needs to be opened, and turn on the manual ball valve to water flowers and plants in the garden using water sprayed from the sprinklers. After the plants and trees are watered sufficiently, they turn off the manual ball valve and walk back to the house.

### SUMMARY

A watering control system comprises a watering signal transmitter; and at least one watering signal receiver, wherein the watering signal transmitter comprises a first processing unit and a wireless transmitting circuit; the watering signal receiver comprises a second processing unit, a wireless receiving circuit, a drive circuit, and a control valve, and an output end of the drive circuit is electrically connected to the control valve; and the first processing unit of the watering signal transmitter stores a first identification code, the second processing unit of the watering signal receiver stores a second identification code, the wireless transmitting circuit of the watering signal transmitter is in communication and connection with the wireless receiving circuit of the watering signal receiver, and when the first identification code sent by the wireless transmitting circuit is matched with the second identification code, the watering signal transmitter controls the watering signal receiver to act.

A watering control method implemented by the watering control system comprises sending, by a watering signal transmitter, a control signal carrying a first identification code; and upon receiving the control signal, obtaining, by a watering signal receiver, a second identification code stored therein, and executing the control signal based on a consistency judgement result between the first identification code and the second identification code.

### BRIEF DESCRIPTION OF THE DRAWINGS

FIG. 1 is a schematic diagram of a watering control system according to at least one embodiment of the present disclosure.

FIG. 2 is a schematic structural diagram of an implementation of a watering control system according to at least one embodiment of the present disclosure.

FIG. 3 is a schematic diagram of one-to-many control between a watering signal transmitter and watering signal receivers according to at least one embodiment of the present disclosure.

FIG. 4 is a flowchart of a watering control method according to at least one embodiment of the present disclosure.

### DETAILED DESCRIPTION OF THE EMBODIMENTS

To describe the technical contents and the objectives and effects achieved in the present disclosure in detail, the present disclosure is described below with reference to implementations and accompanying drawings.

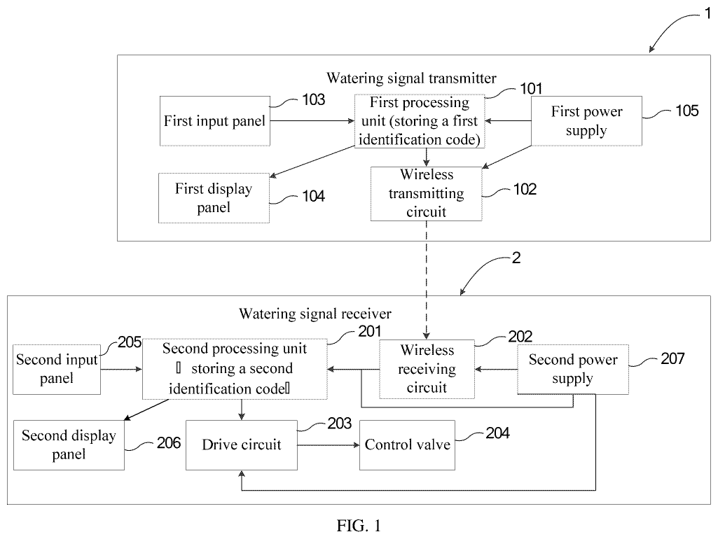

Referring to FIG. 1, a watering control system includes a watering signal transmitter 1 and at least one watering signal receiver 2, where the watering signal transmitter 1 includes a first processing unit 101 and a wireless transmitting circuit 102, the watering signal receiver 2 includes a second processing unit 201, a wireless receiving circuit 202, a drive circuit 203, and a control valve 204, an output end of the drive circuit 203 is electrically connected to the control valve 204, the first processing unit 101 of the watering signal transmitter 1 stores a first identification code, the second processing unit 201 of the watering signal receiver 2 stores a second identification code, the wireless transmitting circuit 102 of the watering signal transmitter 1 is in communication and connection with the wireless receiving circuit 202 of the watering signal receiver 2, and when the first identification code sent by the wireless transmitting circuit 102 is matched with the second identification code, the watering signal transmitter 1 controls the watering signal receiver 2 to act.

In this way, the watering signal transmitter and the watering signal receiver that are capable of remote communication are provided, the watering signal transmitter is provided with the first processing unit and the wireless transmitting circuit, the watering signal receiver is provided with the second processing unit, the wireless receiving circuit, the drive circuit, and the control valve, and the control valve is mounted on the watering pipeline 3. Therefore, the wireless transmitting circuit can send data that can be received by the wireless receiving circuit, enabling remote control of the watering signal receiver by the watering signal transmitter. Moreover, the watering signal receiver may assess the received data, and execute a control instruction from the watering signal transmitter only when the received first identification code is the same as the second identification code saved within the watering signal receiver, thereby allowing for controlled and convenient watering management.

In an optional implementation, the control valve includes a solenoid valve, a diaphragm valve, or a ball valve. In this way, different valves may be used, according to different requirements of actual scenarios, to control whether water can flow through the pipeline or not, thereby broadening the range of possible applications. Moreover, for a scenario involving a plurality of watering signal receivers, each watering signal receiver may use different valves based on respective application locations, or may use other types of valves capable of controlling the flow of water, which are not limited herein.

In an optional implementation, the control valve is a pulse solenoid valve. The pulse solenoid valve is a special type of solenoid valve configured to control the flow of fluids or gases. The pulse solenoid valve generates a pulse signal through rapid switching of an electromagnetic relay, causing the valve to be opened or closed quickly, thereby enabling precise control over the flow of the fluids or gases. The pulse solenoid valve has a fast response speed, allowing for immediate switching based on the control signal. In addition, the degree of valve opening can be controlled precisely based on a required water flow, achieving energy conservation.

In an optional implementation, the first processing unit of the watering signal transmitter stores a first identification code set, and the first identification code set includes more than two first identification codes. In this way, in the case of a plurality of watering signal receivers, the watering signal receivers may store second identification codes whose values are the same as those of the first identification codes. Therefore, by sending different first identification codes, different watering signal receivers are controlled. This allows for control over the opening and closing of the control valve corresponding to respective watering signal receiver according to a specific watering requirement, without the need to uniformly switch all control valves.

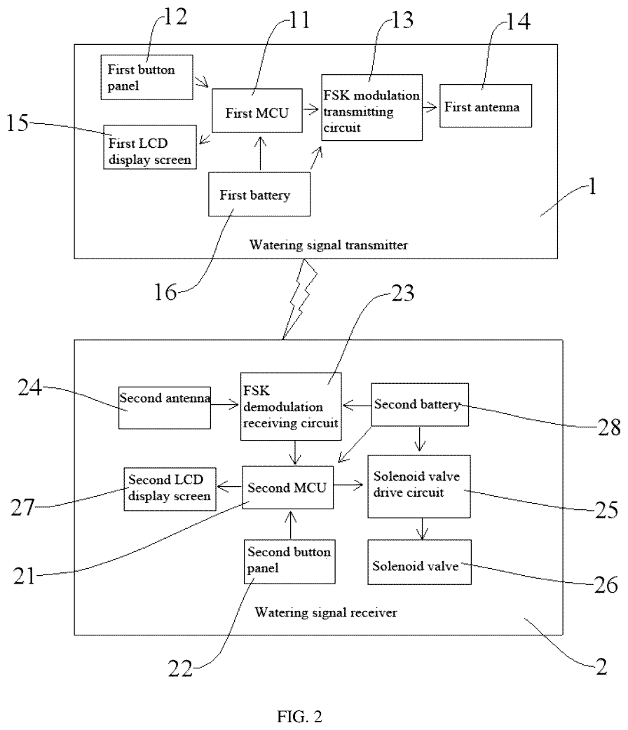

Referring to FIG. 2, in an optional implementation, both the first processing unit and the second processing unit are MCUs, referred to a first MCU 11 and a second MCU 21, which can directly implement the functions of the first processing unit and the second processing unit based on the existing hardware control module.

In an optional implementation, the wireless transmitting circuit 102 includes an FSK modulation transmitting circuit 13 and a first antenna 14. An input end of the FSK modulation transmitting circuit 13 is connected to the first MCU 11, and an output end of the FSK modulation transmitting circuit 13 is connected to the first antenna 14. In this way, information transmission is achieved through the frequency-shift keying (FSK) modulation transmitting circuit, which is easier to implement. Moreover, the FSK modulation transmitting circuit also offers good noise immunity and attenuation resistance, and has been widely used in low- and medium-speed data transmission. In addition, FSK is one of the earlier modulation methods used in information transmission, with mature technology.

In an optional implementation, the wireless receiving circuit 202 includes an FSK demodulation receiving circuit 23 and a second antenna 24. An output end of the FSK demodulation receiving circuit 23 is connected to the second MCU 21, and an input end of the FSK demodulation receiving circuit 23 is connected to the second antenna 24. In this way, the wireless receiving circuit corresponding to the wireless transmitting circuit is constructed. The signal sent by the first antenna 14 is received by the second antenna 24, and the data is initially processed through the FSK demodulation receiving circuit 23 corresponding to the FSK modulation transmitting circuit 13. Finally, the data is transmitted to the second MCU 21 for consistency judgement, enabling the watering signal transmitter to control the watering signal receiver.

In an optional implementation, the first antenna 14 is in communication and connection with the second antennas 24 of the plurality of watering signal receivers 2. In this way, data transmission between the watering signal transmitter 1 and the plurality of watering signal receivers 2 is achieved through communication and connection between the first antenna 14 and the second antenna 24.

In an optional implementation, the watering signal transmitter 1 further includes a first input panel 103, and the first input panel 103 is connected to the first processing unit 101. In this way, the first processing unit can interact with a user through the first input panel, allowing it to receive an input from the user.

In an optional implementation, the watering signal receiver further includes a second input panel 205, and the second input panel 205 is connected to the second processing unit 201. In this way, the second processing unit 201 can interact with a user through the second input panel to manually open or close the control valve 204. The first button panel 12 of the watering signal receiver 2 is convenient for the user to operate, and the second button panel 22 of the watering signal receiver 2 is used for manually opening or closing the solenoid valve 26 or setting an identification code and other operations.

Referring to FIG. 2, in an optional implementation, the first input panel and the second input panel may be configured as button panels, referred to a first button panel 12 and a second button panel 22. The first input panel and the second input panel may alternatively use touch screens or other input panels capable of receiving input information, which is not limited herein.

In an optional implementation, the watering signal transmitter further includes a first display panel 104, and the first display panel is connected to the first processing unit. In this way, the first display panel can display information stored in the first processing unit, such as the first identification code, for a user to select.

In an optional implementation, the watering signal receiver 2 further includes a second display panel 206, and the second display panel is connected to the second processing unit. In this way, the second display panel can show a processing result of the second processing unit, or display a working state of the watering signal receiver 2. The second display panel can also display information stored in the second processing unit, such as the second identification code, for a user to confirm.

Referring to FIG. 2, in an optional implementation, the first display panel and the second display panel may be configured as LCD display screens, referred to a first LCD display screen and a second LCD display screen. The first display panel and the second display panel may also use other panels having display functions, such as, LED display screens. In addition, the display panels may be combined with the button panels, such as touch screens having display functions.

In an optional implementation, the watering signal transmitter further includes a first power supply 105, and the first power supply 105 is connected to the first processing unit 101 and the wireless transmitting circuit 102. The watering signal receiver 2 further includes a second power supply 207, and the second power supply 207 is connected to the second processing unit 201, the wireless receiving circuit 202, and the drive circuit 203. In this way, reliable power is supplied to components in the watering signal transmitter and the watering signal receiver to ensure normal operation of each component.

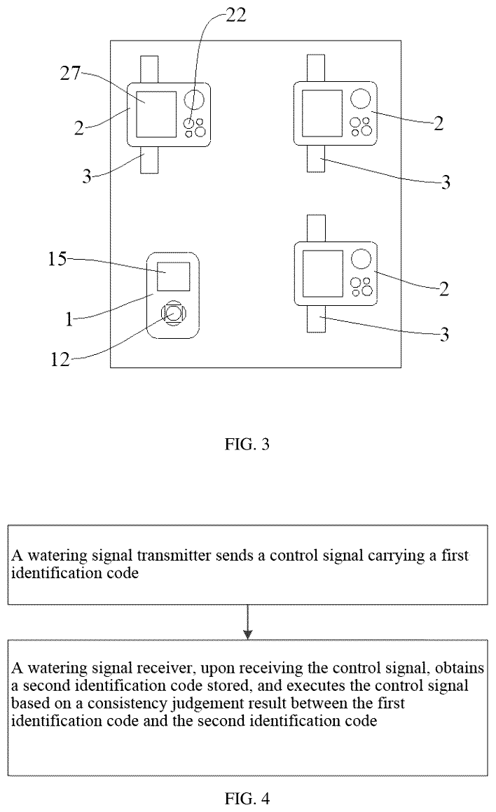

Referring to FIG. 3, in an optional implementation, the first power supply and the second power supply may be configured as batteries, referred to a first battery 16 and a second battery 28. The first power supply and the second power supply may also be directly connected to a power source such as a utility power to achieve power supply, eliminating the need for battery replacement. The use of batteries allows for greater flexibility in positioning the watering signal transmitter and the watering signal receiver.

Referring to FIG. 4, in an optional implementation, the watering signal transmitter 1 may be in the form of a remote controller, allowing a user to obtain information from the first LCD display screen 15 on the watering signal transmitter 1 and send the information through the first button panel 12. One watering signal transmitter 1 may be in communication and connection with a plurality of watering signal receivers 2 which are mounted on a watering pipeline 3. The user can obtain information from the second LCD display screens 27 on the watering signal receivers 2 and directly control the control valves in the watering signal receivers 2 through the second button panels 22. The second LCD display screen of the watering signal receiver 2 is responsible for displaying a working state of the watering signal receiver 2, and the second button panel 22 of the watering signal receiver 2 is used for setting operations of the watering signal receiver 2 or manually opening or closing the solenoid valve.

In an optional implementation, the solution in the present disclosure may be applied to a garden watering scenario. When watering flowers and plants in a garden is needed, a user in a house operates the watering signal transmitter by using the first button panel to first select a first identification code pre-stored in the first MCU, and then send a watering start signal. The watering start signal is broadcast through the FSK modulation transmitting circuit and the first antenna. The plurality of watering signal receivers located in the garden receive the watering start signal through the second antennas. The FSK demodulation receiving circuit extracts the first identification code from the watering start signal, and the second MCU performs a judgement. The watering signal receiver opens the solenoid valve based on the watering start signal only when the second identification code stored in the watering signal receiver is matched with the first identification code, allowing water to flow through the pipeline to the sprinklers for watering. The watering signal receiver does not perform watering when the second identification code stored in the watering signal receiver is not matched with the first identification code. The watering signal transmitter may store a plurality of different first identification codes. The user may operate the first button panel again to select another first identification code and send the watering start signal, and the corresponding watering signal receiver then performs watering. By using the watering signal transmitter, the user can control the watering signal receiver remotely, to start watering, set a watering duration and stop watering, etc., without the need to walk back and forth between the house and the garden. By using a low-power FSK radio frequency modulation-demodulation technology, the user in the house can remotely control the plurality of watering signal receivers located in the garden by using one watering signal transmitter, without the need to walk back and forth between the house and the garden. Based on the actual watering needs of the garden, the user can selectively control watering by using a preset identification code. The watering signal receiver controls a status of the solenoid valve only when the preset identification code is matched with an identification code stored in the watering signal receiver, making the operation convenient.

Referring to FIG. 4, a watering control method includes:
sending, by a watering signal transmitter, a control signal carrying a first identification code.

In an optional implementation, the control signal includes a watering start signal and a watering ending signal, which can control the opening and closing of the control valve in the watering signal receiver, thereby enabling the control of water flow.

Upon receiving the control signal, obtaining, by a watering signal receiver, a second identification code stored therein, and executing the control signal based on a consistency judgement result between the first identification code and the second identification code.

In an optional implementation, the executing the control signal includes: if the control signal is the watering start signal, the watering signal receiver opens the control valve, allowing a pipeline where the control valve is located to start watering; or if the control signal is the watering ending signal, the watering signal receiver closes the control valve, allowing the pipeline where the control valve is located to stop watering. Therefore, the watering start signal and the watering ending signal are converted into control operations for the control valve, enabling the start and stop of watering.

In an optional implementation, the executing, by the watering signal receiver, the control signal based on the consistency determining result between the first identification code and the second identification code includes: determining, by the watering signal receiver, whether the first identification code is the same as the stored second identification code or not, and if yes, executing the control signal. In this way, no intermediate layer is needed to be arranged between the watering signal transmitter and the watering signal receiver, and no complex communication architecture is needed to be constructed between the watering signal transmitter and the watering signal receiver. The watering signal receiver directly determines whether to execute the control signal by determining whether the first identification code is the same as the second identification code stored in the watering signal receiver or not, enabling automatic matching. In addition, the watering signal transmitter may send the control signal through broadcasting, without the need to establish a one-to-one communication channel with the watering signal receiver.

In an optional implementation, the watering signal transmitter sends the control signal carrying more than two first identification codes. In this way, in a case where the second identification codes stored in the watering signal receivers are not exactly identical, a plurality of first identification codes can be sent within one control signal, enabling the opening or closing of control valves corresponding to the plurality of required watering signal receivers as required.

In an optional implementation, the method further includes: sending, by the watering signal transmitter, the first identification code to the watering signal receiver through a code-matching learning mode; and saving, by the watering signal receiver, the first identification code received through code-matching learning as the second identification code. The first identification code is sent to the watering signal receiver by the code-matching learning mode, and the first identification code is sent to and stored in the watering signal receiver as required before sending the control signal, allowing the watering signal receiver to perform consistency judgement upon receiving the control signal. Moreover, the first identification code is written into the watering signal receiver as the second identification code by the code-matching learning mode, enabling remote writing, and improving the operational convenience. It can be learned that the first identification code and the second identification code are identical in value, differing only in the location where they are stored.

Before use, the watering signal transmitter 1 and the watering signal receiver 2 are registered and connected through the code-matching learning mode, and the connection is saved in the second MCU 21 of the watering signal receiver 2. During use, when a user presses the first button panel 12 of the watering signal transmitter 1, the first MCU 11 displays an operation corresponding to a key value on the first LCD display screen, while encoding the data. The encoded data is then modulated and transmitted by the FSK modulation transmitting circuit 13. Upon receiving the data, the FSK demodulation receiving circuit 23 of the watering signal receiver 2 demodulates it into received data. The MCU of the watering signal receiver 2 compares the received data with stored data, to determine whether the received data is matched with the stored data or not. If the received data is matched with the stored data, the solenoid valve drive circuit 25 is activated to open or close the pulse solenoid valve.

In an optional implementation, the watering signal transmitter stores a group identifier, where each group identifier corresponds to at least one first identification code. The sending, by the watering signal transmitter, the control signal carrying the first identification code includes: receiving, by the watering signal transmitter, selection information, where the selection information includes the group identifier; obtaining the first identification code corresponding to the group identifier; and sending the control signal carrying the first identification code. In this way, the first identification codes stored in the watering signal transmitter may be grouped based on positional proximity or similar control valve types, corresponding to the group identifier. This allows the user to control watering by selecting a group based on location or valve type. In a case where many watering signal receivers are provided, the user does not need to remember the location of each watering signal receiver and the corresponding first identification code. Instead, the user can use the group identifier corresponding to the location to control the water signal receivers within the group identifier.

In an optional implementation, the watering signal receiver opens a data receiving window at intervals of a first preset duration, detects whether a signal conforming to a preset coding manner is received or not, and if the signal has been received, keeps the data receiving window open to receive the signal, where a data sending window of the watering signal transmitter is greater than the first preset duration. In this way, the data receiving window is opened at intervals of the first preset duration rather than remaining it open all the time, which is more energy-efficient, and prolongs the service life of a power supply in the watering signal receiver. Moreover, to avoid a data receiving failure, the data sending window of the watering signal transmitter is set to be longer than the first preset duration. This ensures that data sent from the data sending window can be received within the duration of the data receiving window, thereby obtaining information that the watering signal transmitter has sent the control signal. If the received control signal is incomplete, the data receiving window may be kept open, and the watering signal transmitter may be requested to send the control signal again. This ensures that the watering signal receiver can receive the complete control signal while maintaining energy efficiency.

In an optional implementation, by using a low-power FSK radio frequency modulation-demodulation technology, the watering signal receiver 2 activates the FSK demodulation receiving circuit 23 every second to detect whether any radio signal conforming to an encoding manner exists or not. If a radio signal conforming to the encoding manner exists, the data is demodulated and sent to the MCU for processing. When sending a data instruction to the watering signal receiver 2 is needed, the watering signal transmitter 1 sends modulated data for over one second, ensuring that the watering signal receiver 2 can receive the data correctly. The watering control system of the present disclosure is characterized by high real-time performance, fast data transmission rate, strong anti-interference performance, and low transmission and reception power consumption. Both the watering signal transmitter 1 and the watering signal receiver 2 are battery-powered, which solves the problem of high power consumption in traditional radio frequency reception requiring an adapter for power supply and having a limited usage range.

An implementation in which a watering control method is applied to a watering control system is provided. One watering signal transmitter is provided, which stores three different first identification codes: A01, A02, and A03. Five watering signal receivers are provided, three of which store second identification codes A01 and are located in the same area of the garden. The other two watering signal receivers store second identification codes A02 and A03, and are located at different areas of the garden. A user in a house operates the watering signal transmitter by using the first button panel to select the first identification code A01, and then select a required watering operation. After confirming the selection, a watering signal is sent out. The first antenna broadcasts the watering signal. The second antennas of all the five watering signal receivers receive the watering signal. Then, the first identification code A01 is extracted from the watering signal. Only the three watering signal receivers in which the second identification codes A01 are stored activate their solenoid valves for watering, and the other two watering signal receivers do not work. The user in the house operates the watering signal transmitter by using the first button panel to select the first identification code A02, and then select the required watering operation. After confirming the selection, the watering signal is sent out through the first antenna. All the five watering signal receivers extract the first identification code A02 from the watering signal, Only the watering signal receiver in which the second identification code A02 is stored starts watering, and the other four watering signal receivers do not work.

The above description is merely embodiments of the present disclosure, and is not intended to limit the patent scope of the present disclosure. Any equivalent modifications, or direct or indirect applications in the relevant technical field based on the contents of the specification and accompanying drawings of the present disclosure shall equally fall within the patent protection scope of the present disclosure.

What is claimed is:

1. A watering control system, comprising:
a watering signal transmitter; and
at least one watering signal receiver, wherein
the watering signal transmitter comprises a first processing unit and a wireless transmitting circuit;
the watering signal receiver comprises a second processing unit, a wireless receiving circuit, a drive circuit, and a control valve, and an output end of the drive circuit is electrically connected to the control valve; and
the first processing unit of the watering signal transmitter stores a first identification code, the second processing unit of the watering signal receiver stores a second identification code, the wireless transmitting circuit of the watering signal transmitter is in communication and connection with the wireless receiving circuit of the watering signal receiver, and when the first identification code sent by the wireless transmitting circuit is matched with the second identification code, the watering signal transmitter controls the watering signal receiver to act.

2. The watering control system according to claim 1, wherein the control valve comprises at least one of a pulse solenoid valve, a diaphragm valve, and a ball valve.

3. The watering control system according to claim 1, wherein the first processing unit of the watering signal transmitter stores a first identification code set, and the first identification code set comprises more than two first identification codes.

4. The watering control system according to claim 1, wherein the wireless transmitting circuit comprises a frequency-shift keying (FSK) modulation transmitting circuit and a first antenna, an input end of the FSK modulation transmitting circuit is connected to the first processing unit, and an output end of the FSK modulation transmitting circuit is connected to the first antenna.

5. The watering control system according to claim 4, wherein the wireless receiving circuit comprises an FSK demodulation receiving circuit and a second antenna, an output end of the FSK demodulation receiving circuit is connected to the second processing unit, and an input end of the FSK demodulation receiving circuit is connected to the second antenna.

6. The watering control system according to claim 5, wherein the first antenna is in communication and connection with the second antennas of a plurality of watering signal receivers.

7. The watering control system according to claim 1, wherein the watering signal transmitter further comprises a first input panel, and the first input panel is connected to the first processing unit.

8. The watering control system according to claim 1, wherein the watering signal receiver further comprises a second input panel, and the second input panel is connected to the second processing unit.

9. The watering control system according to claim 1, wherein the watering signal transmitter further comprises a first display panel, and the first display panel is connected to the first processing unit.

10. The watering control system according to claim 1, wherein the watering signal receiver further comprises a second display panel, and the second display panel is connected to the second processing unit.

11. The watering control system according to claim 1, wherein the watering signal transmitter further comprises a first power supply, and the first power supply is connected to the first processing unit and the wireless transmitting circuit.

12. The watering control system according to claim 1, wherein the watering signal receiver further comprises a second power supply, and the second power supply is connected to the second processing unit, the wireless receiving circuit, and the drive circuit.

13. A watering control method, implemented by the watering control system according to claim 1, comprising:
sending, by a watering signal transmitter, a control signal carrying a first identification code; and
upon receiving the control signal, obtaining, by a watering signal receiver, a second identification code stored therein, and executing the control signal based on a consistency judgement result between the first identification code and the second identification code.

14. The watering control method according to claim 13, wherein the control signal comprises a watering start signal; and
the executing the control signal comprises:
activating, by the watering signal receiver, a solenoid valve, allowing a pipeline where the solenoid valve is located to start watering.

15. The watering control method according to claim 13, wherein the control signal comprises a watering ending signal; and
the executing the control signal comprises:
deactivating, by the watering signal receiver, a solenoid valve, allowing a pipeline where the solenoid valve is located to stop watering.

16. The watering control method according to claim 13, wherein the executing, by the watering signal receiver, the control signal based on the consistency determining result between the first identification code and the second identification code comprises:
determining, by the watering signal receiver, whether the first identification code is the same as the stored second identification code or not, and if yes, executing the control signal.

17. The watering control method according to claim 13, wherein the watering signal transmitter sends the control signal carrying more than two first identification codes.

18. The watering control method according to claim 13, further comprising:
sending, by the watering signal transmitter, the first identification code to the watering signal receiver through a code-matching learning mode; and
saving, by the watering signal receiver, the first identification code received through code-matching learning as the second identification code.

19. The watering control method according to claim 13, wherein the watering signal transmitter stores a group identifier, and each group identifier corresponds to at least one first identification code; and
the sending, by the watering signal transmitter, the control signal carrying the first identification code comprises:
receiving, by the watering signal transmitter, selection information, wherein the selection information comprises the group identifier;
obtaining the first identification code corresponding to the group identifier; and
sending the control signal carrying the first identification code.

20. The watering control method according to claim 13, wherein the watering signal receiver opens a data receiving window at intervals of a first preset duration, detects whether a signal conforming to a preset coding manner is received or not, and if the signal has been received, keeps the data receiving window open to receive the signal; and
a data sending window of the watering signal transmitter is greater than the first preset duration.
